(19) United States
(12) Patent Application Publication
(10) Pub. No.: US 2012/0070229 A1
(43) Pub. Date: Mar. 22, 2012

(54) APPARATUS FOR SUPPORTING THE HULL OF A VESSEL

(76) Inventor: Martin Walter lawn, Arrowtown (NZ)

(21) Appl. No.: 13/322,130

(22) PCT Filed: May 25, 2010
(86) PCT No.: PCT/NZ2010/000095

§ 371 Date: Nov. 22, 2011

(30) Foreign Application Priority Data
May 25, 2009 (NZ) 577188

(51) Int. Cl. B63C 3/02; F16M 11/06; F16B 45/00; F16M 11/22

(52) U.S. Cl. 405/1; 248/678; 248/674

(57) ABSTRACT

The invention relates to an apparatus (10) for supporting the hull of a vessel. The apparatus includes two support members (11, 12) that are adapted to cooperate, each support member having an inclined surface (13) and an engagement means (16) for cooperation with a complementary engagement means on the other support member, such that when the two support members are engaged with each other, a support for the hull of a vessel is formed from surfaces of the support members that incline towards each other.

This invention relates to an apparatus for supporting the hull of a vessel.

As used throughout the specification, the term “vessel” is intended to refer to any watercraft with at least one hull, including but not limited to a boat, canoe, catamaran, dinghy, jet-ski, or kayak.

### BACKGROUND TO THE INVENTION

Hull supports are used to support the hull of a vessel while the vessel is out of the water and to hold the hull such that the vessel is level with the position of the vessel in the water. Some of these hull supports can also be used to move a vessel into or out of the water and to prevent damage to the hull during transition, for example, caused by ground scrapes.

The use of a hull support which is fixed to a foundation is known in the art, for example, as described in U.S. Pat. No. 5,186,576. However, this type of support is mounted into the foundation and therefore cannot be used elsewhere without demounting. Portable hull supports are also known in the art, for example, U.S. Pat. No. 5,267,811. Although these supports are transportable, they are large, heavy, cumbersome and expensive.

It is an object of this invention to provide an apparatus for supporting the hull of a vessel that will solve these problems.

### SUMMARY OF THE INVENTION

According to a first aspect of the invention there is provided an apparatus comprising two support members that are adapted to cooperate and form a support for the hull of a vessel, each support member having an inclined surface and an engagement means for cooperation with a complementary engagement means on the other support member, such that when the two support members are engaged with each other, a support for the hull of a vessel is formed from surfaces of the support members that incline towards each other.

The shape of the support may be determined by the shape of the hull, for example, the support may be substantially V-shaped, such as a shallow V-shape.

Each engagement means is preferably one that allows quick and easy connection and disconnection between the support members. Optionally the support members may be able to be locked together when engaged. In one preferred embodiment, the engagement means on the first support member is a recess and the engagement means on the second support member is a correspondingly shaped protrusion. In another preferred embodiment, the engagement means on both support members is a swivel eye bolt for connection using a removable clip or shackle.

Each support member may contain a hook or other means for use in strapping the apparatus to the vessel.

Each support member may be polygonal in cross-section, for example, square shaped. However, in a preferred embodiment each support member is a roller. Each roller may be substantially conical in shape, for example, each of the rollers may be a truncated cone with a base and a flattened apex. Each engagement means may be located at the flattened apex of the corresponding cone. Each hook or other means for use in strapping the apparatus to the vessel, if present, may be located at the base of the corresponding cone.

It is advantageous if the support members are inflatable and are able to float on water, for example, if they are inflatable buoys.

According to a second aspect of the invention there is provided a method of moving a vessel along a surface, the method comprising: (i) positioning at least one abovementioned apparatus having rollers underneath the hull of the vessel to support the hull and prevent the hull from contacting the surface; and (ii) pushing the vessel such that the apparatus or each of the apparatuses rolls along the surface and protects the hull from damage caused by contact with the surface.

Optionally the apparatus or each of the apparatuses may be strapped to the vessel.

### DETAILED DESCRIPTION OF THE INVENTION

A preferred embodiment of the apparatus for supporting the hull of a vessel will now be described, by way of example only, with reference to the accompanying drawings in which:

FIG. 1 is a front view of the apparatus in an unengaged state.

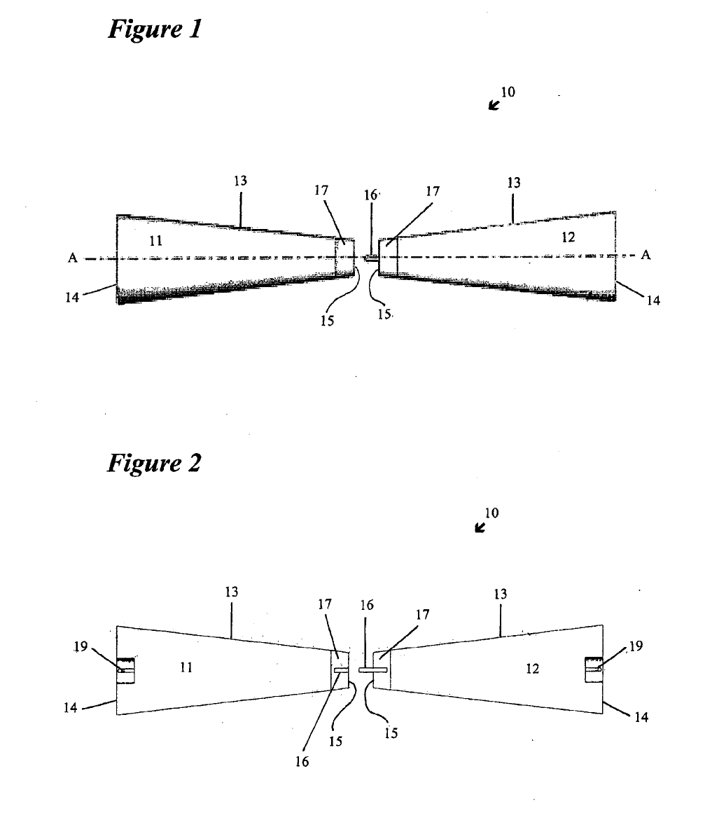

FIG. 2 is a cross-sectional view through line A--A of FIG. 1.

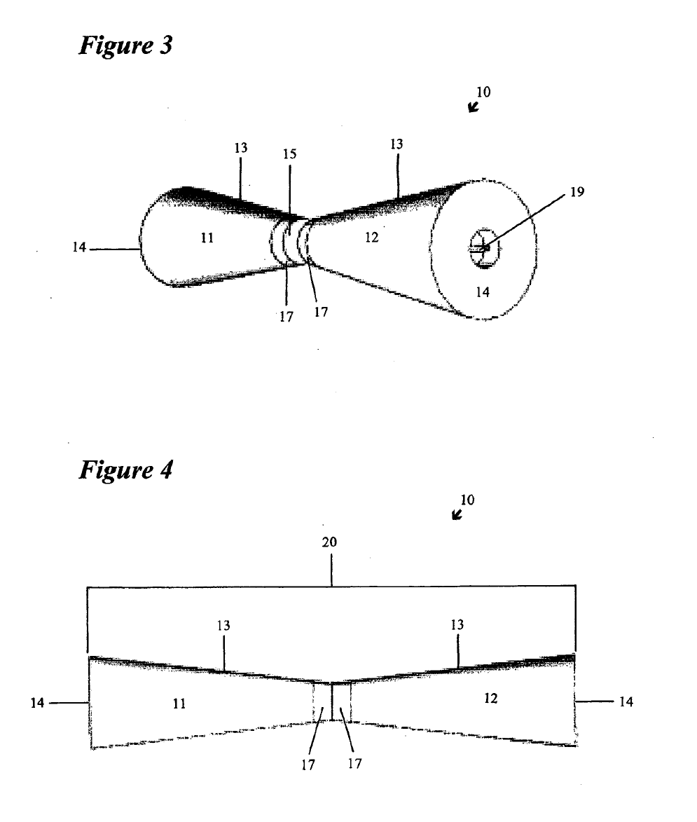

FIG. 3 is a perspective view of the apparatus in an unengaged state.

FIG. 4 is a front view of the apparatus in an engaged state.

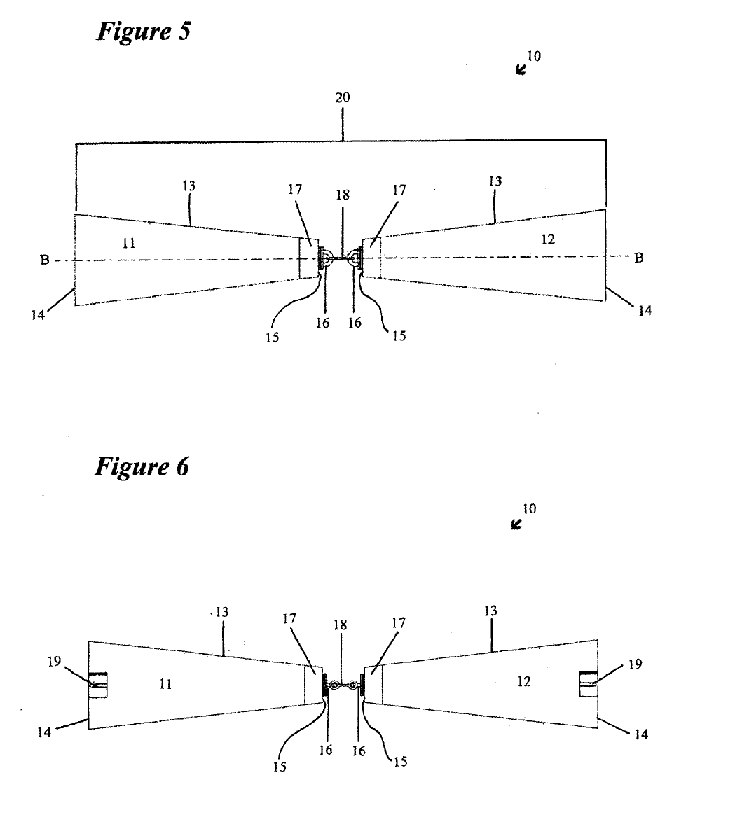

FIG. 5 is a front view of an alternative embodiment of the apparatus in an engaged state.

FIG. 6 is a cross-sectional view through line B--B of FIG. 5.

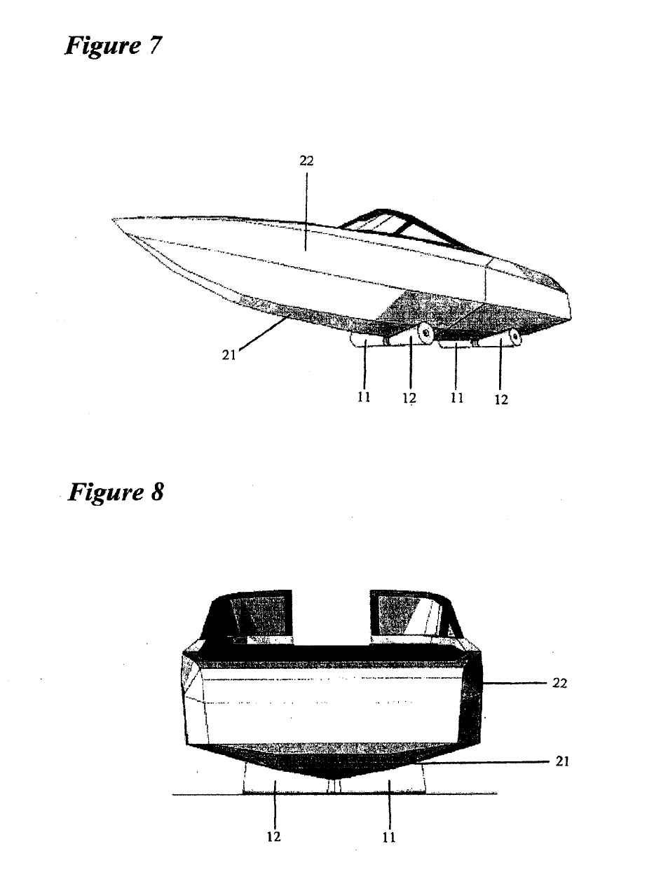

FIG. 7 is a perspective view of the apparatus (×2) in use.

FIG. 8 is a rear view of the apparatus in use.

The invention relates to an apparatus 10 comprising two support members 11, 12 that are adapted to cooperate and form a support for the hull of a vessel, each support member having an inclined surface 13 and an engagement means 16 for cooperation with a complementary engagement means on the other support member, such that when the two support members are engaged with each other, a support 20 for the hull 21 of a vessel 22 is formed from surfaces of the support members that incline towards each other.

Each of the support members is most preferably a roller but, if there is no need to move the vessel, the cross-section of each support member can be oval, square, rectangular, or any other polygonal shape. In the preferred embodiment the apparatus 10 comprises a first roller 11 and a second roller 12 as the support members. The rollers are adapted to engage with each other to form a support 20 for the hull 21 of a vessel 22.

The ability of the rollers to engage to form the support for the hull and disengage when not in use is a significant advantage for storage of the apparatus on a vessel where space is limited. Accordingly, the apparatus is much more portable than the hull supports known in the art.

In the preferred embodiment, the rollers 11, 12 are inflatable articles that can float on the surface of the water, such as buoys. This makes the apparatus lighter than known hull supports and less likely to be lost overboard. It also allows the rollers to serve other purposes when not being used as a hull support, for example, as jetty buffers to prevent rubbing damage to the hull from moorings. The rollers can be inflatable articles made of plastic, for example, polyvinyl chloride, polyester, Hypalon, latex, or any other rubber based material. The rollers can be inflated using a pump, such as a foot pump.

The first roller 11 is substantially conically shaped, with an inclined surface 13, a base 14 and a flattened apex 15. Similarly, the second roller 12 is substantially conically shaped, with an inclined surface 13, a base 14 and a flattened apex 15.

The size and shape of the rollers 11, 12 will depend on the size and shape of the hull 21 to be supported. In the preferred embodiment, the two rollers are the same size and the length of each roller from base to apex is approximately 650 cm and the length of the apparatus in an engaged state is approximately 1,300 cm. The width of each roller at the base is approximately 250 cm with the width at the apex being approximately 100 cm.

When the two rollers 11, 12 are engaged, a support 20 for the hull of a vessel is formed from surfaces of the rollers that incline towards each other. The shape of the support will be determined by the shape of the hull. In the embodiments shown, the support 20 is a shallow V-shape.

FIGS. 7 and 8 show the apparatus in use to support the hull 21 of a vessel 22. The circular cross-section of the rollers 11, 12 allows the rollers to rotate and thereby assist in moving the vessel, for example, into or out of the water. The rollers 11, 12 make the task of pushing a vessel 22 which has run aground much easier and ensures that the hull 21 is protected from damage caused by scratches from rocks or shells.

The first roller 11 contains an engagement means 16 at the flattened apex 15 to cooperate with a complementary engagement means 16 at the flattened apex 15 of the second roller 12. Each engagement means is preferably one that allows quick and easy connection and disconnection between the rollers. In the preferred embodiment shown in FIGS. 1 to 4, the engagement means 16 on the first roller 11 is a recess in a solid plastic housing 17 and the engagement means 16 on the second roller 12 is a correspondingly shaped protrusion, namely a stainless steel thread, in a solid plastic housing 17. In the alternative embodiment shown in FIGS. 5 and 6, the engagement means 16 on both rollers 11, 12 is a swivel eye bolt in a plastic housing 17 for connection using a removable stainless steel clip or shackle 18.

The base 14 of each roller 11, 12 contains a flush mounted stainless steel hook 19 for use in strapping the apparatus to the vessel 22 to assist in moving the vessel, for example, by running a strap tied to both hooks around the vessel. The hooks also allow the unengaged rollers to be tied to the vessel when the rollers are being used as jetty buffers.

While some preferred aspects of the invention have been described by way of example, it should be appreciated that modifications and/or improvements can occur without departing from the scope of the invention as set out in this specification. It will be appreciated that each of the support members could be square or rectangular rather than a roller.

The terms comprise, comprises, comprising, or comprised, if and when used herein, should be interpreted non-exclusively, that is, as conveying “consisting of or including”.

1. An apparatus comprising two support members that are adapted to cooperate and form a support on a ground surface for the hull of a vessel which prevents the hull from contacting the ground surface, each support member having an inclined surface and an engagement means for cooperation with a complementary engagement means on the other support member, such that when the two support members are engaged with each other on a ground surface, a support for the hull of a vessel is formed from surfaces of the support members that incline towards each other, wherein the engaged support members are able to be disengaged from one another by uncoupling the engagement means on each support member, the support members capable of floating on the surface of water.

2. An apparatus according to claim 1, wherein the support is substantially V-shaped.

3. An apparatus according to claim 2, wherein the support has a shallow V-shape.

4. An apparatus according to claim 1, wherein the support members can be locked together when engaged.

5. An apparatus according to claim 1, wherein the engagement means on the first support member is a recess and the engagement means on the second support member is a correspondingly shaped protrusion.

6. An apparatus according to claim 4, wherein the engagement means on both support members is a swivel eye bolt for connection using a removable clip or shackle.

7. An apparatus according claim 1, wherein each support member contains a hook or other means for use in strapping the apparatus to the vessel.

8. An apparatus according to claim 1, wherein each support member is polygonal in cross-section.

9. An apparatus according to claim 8, wherein each support member is square in cross-section.

10. An apparatus according to claim 1, wherein each support member is a roller.

11. An apparatus according to claim 10, wherein each of the rollers is substantially conical in shape.

12. An apparatus according to claim 11, wherein each roller is a truncated cone with a base and a flattened apex.

13. An apparatus according to claim 12, wherein each engagement means is located at the flattened apex of the corresponding cone.

14. An apparatus according to claim 12, wherein each hook or other means for use in strapping the apparatus to the vessel, if present, is located at the base of the corresponding cone.

15. An apparatus according to claim 1, wherein the support members are inflatable.

16. An apparatus according to claim 15, wherein each support member is an inflatable buoy.

17. A method of moving a vessel along a ground surface, the method comprising: positioning at least one apparatus having rollers according to claim 10 underneath the hull of the vessel to support the hull and prevent the hull from contacting the ground surface; and pushing the vessel such that the apparatus or each of the apparatuses rolls along the ground surface and protects the hull from damage caused by contact with the ground surface.

18. A method according to claim 17, wherein the apparatus or each of the apparatuses is strapped to the vessel.
